(19) United States
(12) Patent Application Publication
(10) Pub. No.: US 2016/0162602 A1
(43) Pub. Date: Jun. 9, 2016

(54) METHODS AND APPARATUS FOR PROXIMALLY INFORMED DATABASE SEARCHES

(71) Applicants: Stillman Bradish, Washington, DC (US); Patrick Parodi, Washington, DC (US); Matthew S. Corson, Gillette, NJ (US)

(72) Inventors: Stillman Bradish, Washington, DC (US); Patrick Parodi, Washington, DC (US); Matthew S. Corson, Gillette, NJ (US)

(21) Appl. No.: 14/869,973

(22) Filed: Sep. 29, 2015

Related U.S. Application Data
(63) Continuation-in-part of application No. 14/617,983, filed on Feb. 10, 2015.
Application No. 14/617,983 is a continuation-in-part of application No. PCT/US2014/043573, filed on Jun. 23, 2014.
Application No. PCT/US2014/043573 is a continuation-in-part of application No. 14/620,590, filed on Feb. 12, 2015.
(60) Provisional application No. 61/938,836, filed on Feb. 12, 2014.
(60) Provisional application No. 61/838,110, filed on Jun. 21, 2013.
(60) Provisional application No. 61/939,032, filed on Feb. 12, 2014.
(60) Provisional application No. 62/057,012, filed on Sep. 29, 2014.
(60) Provisional application No. 62/056,986, filed on Sep. 29, 2014.
(60) Provisional application No. 62/060,201, filed on Oct. 6, 2014.

(51) Int. Cl. G06F 17/30

(52) U.S. Cl. CPC G06F 17/30985; G06F 17/30477

(57) ABSTRACT

In one embodiment, a device-initiated search where a search device may initiate a proximity-informed search of one or more datastores based on processed proximity information strings, and then updates another datastore with the results learned from the first datastore and/or generates a second search query that may be forwarded to a second datastore. In another embodiment, a proximally-based database search may be initiated by a database when a search device sends proximity information (information strings geolocation information) to a first datastore, which may derive search information from the proximity information received from the search device, and then initiates a query of a second datastore with the derived information. The second datastore returns search results to the search device. In some embodiments, the second datastore may return results to the first datastore, which may then processes the results and then returns the processed results to the search device.

### RELATED APPLICATIONS

The present application claims the benefit of U.S. Provisional Patent Application Ser. No. 62/056,986 filed on Sep. 29, 2014; claims the benefit of U.S. Provisional Patent Application Ser. No. 62/057,012 filed on Sep. 29, 2014; claims the benefit of U.S. Provisional Patent Application Ser. No. 62/060,201 filed on Oct. 6, 2014; is a continuation in part of U.S. patent application Ser. No. 14/617,983 filed on Feb. 10, 2015 which claims the benefit of U.S. Provisional Patent Application Ser. No. 61/938,836 filed on Feb. 12, 2014 and which is a continuation in part of International Application PCT/US2014/043573 filed on Jun. 23, 2014 which claims the benefit of U.S. Provisional Patent Application Ser. No. 61/838,110 filed on Jun. 21, 2013; is a continuation in part of U.S. patent application Ser. No. 14/620,590 filed on Feb. 12, 2015 which claims the benefit of U.S. Provisional Patent Application Ser. No. 61/939,032 filed on Feb. 12, 2014; is related to U.S. patent application Ser. No. 14/610,250, filed Jan. 30, 2015; is related to U.S. Patent Application No. 14/603,876, filed Jan. 23, 2015; is related to U.S. patent application Ser. No. 14/610,102, filed Jan. 30, 2015; and is related to U.S. patent application Ser. No. 14/614,723, filed Feb. 5, 2015. Each of the above listed patent applications are hereby expressly incorporated by reference herein in their entireties.

### TECHNICAL FIELD

The present invention relates generally to capturing and storing data transmitted by wireless devices.

### SUMMARY

In one embodiment, a device-implemented method comprises receiving, by an electronic device, one or more information strings from one or more wireless devices; transmitting, by the electronic device, a query to a first database, wherein the parameters of the query contain the information strings or strings being communicated and information associated with the information strings; transmitting, by the first database, a second query to a second database, wherein the parameters of the second query may contain results of the first query and/or information from the first query; receiving, by the first database, results of the second query from the second database; receiving, by the electronic device, results of the first query from the first database, based on information derived from the results of the second query and the results of the first query. A database may, and in some embodiments does, include an interface including a receiver for receiving queries and/or other signals and a transmitter for communicating information, signals and/or query results to other devices. The database may and in some embodiments does include a processor and memory which are coupled to the interface. The processor controls the database to receive, process and respond to queries as described herein. The memory may be implemented as RAM, ROM or another non-transitory storage device capable of storing strings, information and/or a control routine. The control routine, when executed by the processor controls the database to operate in the manner described herein and to processes queries as well as store data, information and/or strings which maybe and sometimes are associated with content.

In another embodiment, a processor-implemented method comprises receiving, by a electronic device, one or more information strings from one or more wireless devices ; transmitting, by the electronic device, the one or more strings to a database to be used as search input to a query; receiving, by the electronic device, a search output from the database; and transmitting, by the electronic device, information derived from the one or more information strings and the search results to a second database.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 shows components of a system for proximally-informed searching.

FIG. 2 shows steps performed by a system for proximally-informed searching, according to a method embodiment.

FIG. 3 shows components of a system for proximally-informed searching.

FIG. 4 shows steps performed by a system for proximally-informed searching, according to a method embodiment.

### DETAILED DESCRIPTION

The subject matter described herein generally relates to, and incorporates by reference, International Patent Application Serial No. PCT/US2013/068872 (Docket No. WFN-XXXX-002-PCT), entitled “System and Method for Storing and Retrieving Information Associated with a Network Location,” filed Nov. 7, 2013; U.S. Provisional Patent Application Ser. No. 61/938,845 (Docket No. WRG-REGY-001), entitled “Methods and Systems for Managing IDS in WNS Using API,” filed Feb. 12, 2014; U.S. Provisional Patent Application Ser. No. 61/968,585 (Docket No. WRG-REGY-001-PRO2), entitled “Methods and Systems for Managing IDS in WNS Using API,” filed Mar. 21, 2014; and U.S. Provisional Patent Application Ser. No. 61/938,836 (Docket No. WRG-MDNT-001), entitled “Methods and Systems for Associating Social Media to Device Identifiers,” filed Feb. 12, 2014. As mentioned, each of these previously filed patent applications are incorporated by reference in their entirety.

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art having possession of this disclosure, should be considered within the scope of the invention.

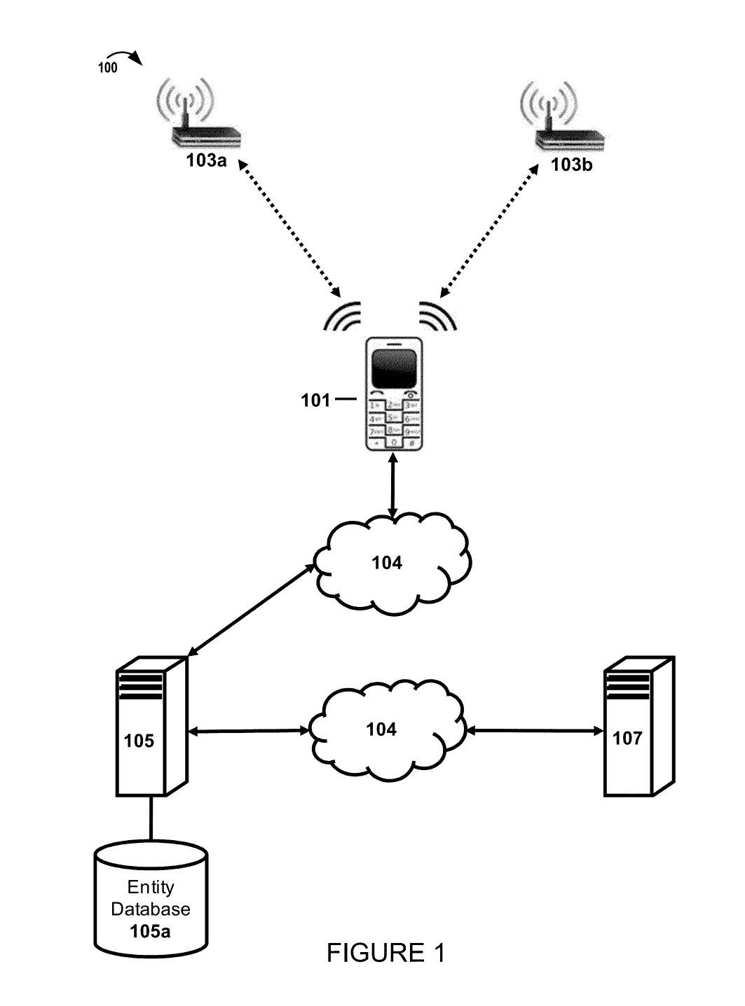

FIG. 1 shows components of an exemplary system embodiment. This embodiment may be a device-initiated search where a fixed or mobile search device 101 may initiate a proximity-informed search of one or more datastores 105, 107 based on processed proximity information strings, and then updates another datastore 105, 107 with the results learned from the first datastore 105, and/or updates a second search query that was sent to a second datastore 107.

A search device 101 may be any fixed or mobile computing device comprising non-transitory machine-readable storage medium and a processor executing software modules that render the search device 101 capable of performing various tasks and processes described herein. Non-limiting examples of a search device 101 may include a smartphone, table, laptop computer, a workstation computer, or the like. The search device may comprise a wireless interface allowing the search device 101 to communicate wirelessly with wireless devices 103, among other computing devices. In some embodiments, the search device 101 may receive wireless signals from wireless devices 103 through a wireless protocol. In some embodiments, the search device 101 may receive network information strings from an intermediate device, which may have received the wireless signals from wireless devices 103 and then forward the network information strings to the search device 101 for further processing. The search device 101 may receive wireless signals using any suitable protocol, such as WiFi, Bluetooth®, ZigBee, NFC, 3G, 4G, LTE, among others. Each wireless signal may carry a network information string that contains information describing the wireless device 103 that broadcasted the particular wireless signal. The search device 101 may be communicatively coupled to one or more datastores 105, 107 using any suitable combination of public and private networking technology. The search device 101 may extract information strings from the wireless signals and then forward them to the datastores 105, 107 as a query. That is, datastores 105, 107 may comprise searchable data repositories (e.g., a database 106, an online search engine) that may receive search queries generated by the search device 101. The search queries generated by the search device 101 may contain parameters that are based on the extracted information strings.

In some embodiments, a search device 101 may determine whether the information string data is in a suitable form for querying datastores 105, 107, and may format the data of the information strings to be better suited to query the datastores 105, 107. In some embodiments, the search device 101 may be capable of processing the network information strings according to a number of factors, in order to generate a search query. The search queries generated by the search device using the network information strings, may be transmitted to the datastores 105, 107 such that data from the network information strings may represent the search parameters of the generated search query.

In some implementations, a search device 101 may be configured to automatically generate a first query when certain types of data is extracted from information strings carried by wireless signals. The search device 101 may be triggered to generate the first query, based on certain criteria. Non-limiting examples of triggers that may prompt the search device 101 to automatically generate a first search query may include, an SSID, a proximity to a wireless device 103 broadcasting an information string, a particular IP address, a particular MAC address, a type of wireless protocol, a particular type of device, among other identifiers. Upon receiving triggering data, the search device 101 may generate the first search query to simulate a useful query at one or more datastores 105, 107.

Wireless devices 103 may be any fixed or mobile electronic device comprising a wireless interface card or chip, which may broadcast wireless signals using any suitable protocol (e.g., WiFi, Bluetooth®, NFC, 3G, 4G, LTE, ZigBee, RFID, OFID). Non-limiting examples of wireless devices 103 may include WiFi routers, iBeacons®, RFID tags, cellular telephones, personal computers (e.g., laptops, desktops), tablet devices, and any other product capable of producing wireless communications signals, such as appliances, cars, and toys, among others. Wireless signals may carry a network information string, which may contain information describing each of the wireless devices 103 broadcasting wireless signals. In some embodiments, the wireless device 103 may comprise a processor and/or a non-transitory machine-readable storage medium. Information strings may comprise one or more types of data describing a wireless network, based on the originating wireless device 103. Non-limiting examples of the types of data in a network information string may include an SSID, a MAC address, an IP address, and the like.

Datastores 105, 107 may be any collection one or more computing devices comprising non-transitory machine-readable storage media that may be searched by an external processor or a processor of the datastore 105, 107. In some embodiments, datastore 105, 107 may be a single physical device, such as a server computer housing a database. In some embodiments, datastores 105, 107 may comprise an enterprise infrastructure comprising of a distributed network environment. In some cases, datastores 105, 107 may be private entities having a private database 105a, or a data search service that may or may not store the data sought by the query, but may offer one or more services for search and organizing data, such as a commercially-available search engine (e.g., Google®, Yahoo®), or other cloud-service offering (e.g., Box®, Dropbox®).

In FIG. 1, a first datastore 105 may be an network server of an entity that provides data storage through a gateway server, or other access device. The first datastore 105 may comprise an entity database 105a that stores searchable data in a machine-readable memory. The first datastore 105 may receive a first query prepared by the search device 105. The search parameters of the first query may comprise the network information strings and data associated with the information strings. The first datastore 105 may execute the search query against the entity database 105a in order to identify any stored information related to the information string or associated information that may be stored in records of the entity database 105a. Relevant records may be retrieved, and information satisfying the parameters of the first query may be derived from the retrieved records. In some embodiments, the first datastore 105 may dynamically produce a second query that may be transmitted to a second datastore 105. The first datastore may utilize any number of predetermined rules for generating the second query, whose parameters may be a revision of the parameters of the first query. The parameters of the second query may include the information strings and information derived from the first datastore 105. The first datastore 105 may then transmit the second query to the second datastore 107. The second datastore 107, in FIG. 1, may be commercially-available public search engine (e.g., Google®, Bing®, Yahoo®). However it should be appreciated that, like any datastore 105, 107, the second datastore may be any combination of non-transitory machine-readable storage media storing searchable data that is accessible to a search device 101.

After receiving the second query, a second datastore 107 may execute the second query 107 that was received from the first datastore 105. The second datastore 107 may be communicatively coupled to the first datastore 105 and/or the search device 101. The second datastore 107 may then return a set of results, based on the second query, to the first datastore 105, which may return the second results to the search device 101. In some embodiments, the second set of results may be analyzed by the first datastore 105 to determine whether the second results may be used to update records of the first datastore 105.

As an example, a search device 101 may be a smartphone associated with a user, who is located at a coffeehouse that provides a wireless access point 103a to patrons. The smartphone 101 may receive wireless signals from the wireless access point 103a and a second wireless device 103b. The wireless access point 103a may transmit an SSID as part of an information string, which is carried by the wireless signals broadcast by the wireless access point 103a. The SSID of the broadcasted information string may advertise the name of the coffeehouse in the form of simplified text, which may trigger a query process to be performed by the user's smartphone 101.

The user's smartphone 101 may be configured to automatically generate and transmit a query to datastores 105, 107 whenever a certain type of data is extracted from information strings. After extracting an information string from the signal of the wireless station The smartphone 101 may transmit a first query to a first datastore 105 of a food review service; the parameters of the first query may include the information string of the wireless access point 103a. The first query may be executed against the records of the entity database 105a, which may yield a record associated with the information string, based on a match of the SSID. The first datastore 105 may pull information from the matching record, and then generate a second query based on the information pulled from the entity database 105a and the information string of the wireless access point 103a. The second query may transmitted to a second datastore 107, which may be a search engine (e.g., Google®, Bing®, Yahoo®). The second datastore 107 may execute the second query based on the second set of parameters. The second set of results from the second query may then be returned to the smartphone 101. In some embodiments, the second results may be sent directly to the smartphone 101 from the second datastore 107, or indirectly, through the first datastore 105.

In some embodiments, the first datastore 105 may use the second results from the second data store 107 to automatically update or generate a record containing information relating the information string. In such embodiments, if the second results comprise an updated street address for the coffeehouse due to a search of geographic-information (e.g., Google Maps®), the first datastore 105 may automatically update the database record of the coffeehouse's network information string, which is stored in the entity database 105a. After updating the data stored by the first datastore 105, the first datastore may transmit the second results to the search device 101.

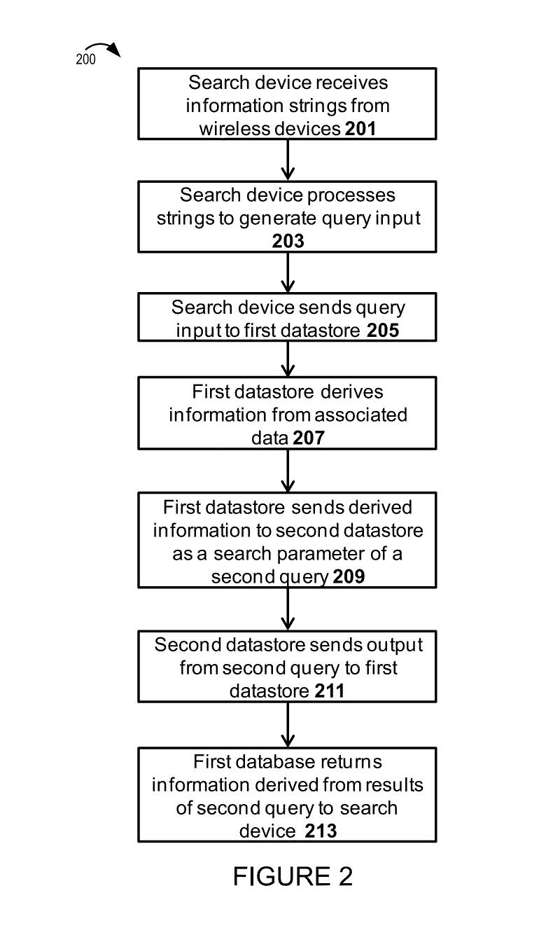

FIG. 2 shows steps performed by processors and software modules, according to an exemplary embodiment. In this exemplary embodiment, a proximity-informed database search may be automatically initiated by a search device. The search may be based on processed proximity information (e.g., information strings) and associated information pulled from sources such as Google®. The search results may be used to then update another database, using the results learned from the first and/or second datastore records.

In a first step 201, a search device may receive information strings from wireless devices. The search device may be receive any number of wireless signals, from any number of sources. The search device may select a subset of wireless signals from which the search device will extract an information string.

In a next step 203, the search device processes the information strings in order to generate a query. The search device may concatenate multiple information strings, or parts of information strings. The search device may parse data of the information strings to be more suitable for executing the search. The search device may also parse data of the information strings to generate a customized search query based on one or more factors.

In a next step 205, the search device may transmit the generated query to a first datastore. The generated query may use the data of the information string as the search parameters issued to the first datastore. The search device may also send, along with the information strings, data associated with the information strings.

In a next step 207, after the first datastore identifies records containing data associated with the information string, the first datastore may generate a second query that may be transmitted to a second datastore. The parameters of the second query may include the information strings and the data associated with the information strings pulled from records of the first datastore. In some cases, a new query may be generated for the second query. And, in some cases, the parameters of the first query may be, and sometimes are, modified based on the data identified from the first query, e.g., as part of generating the second query.

In a next step 209, after generating the second query using the data retrieved from the first datastore as parameters, the first datastore may transmit the second query to the second datastore, which may execute the second query. The first datastore may transmit the second query using any suitable format. In some embodiments, the first datastore may be able to detect a suitable format. In some embodiments, a suitable format may be pre-programed into the first datastore. As such, the first datastore may automatically format search strings of the query.

In a next step 211, after receiving the second search query and subsequently executing the second search query, the second datastore may return a second set of results to the first datastore. In some embodiments, the first datastore may update one or more records based on the second results from the second datastore. In some embodiments, the first datastore may update database records based on the results from the second datastore. In some embodiments, the first datastore may perform an analysis to determine whether records of the first datastore should be updated, in view of the second results.

In a next step 213, upon receiving the second results from the second datastore, the first database may proceed to return the second results to the search device. In some embodiments, the first datastore may perform an analysis on the second search result to identify any information that may be derived from the second search results. In some embodiments, the first datastore may simply forward the second results onward to the search device. The second results, or information derived from the second results, may then be transmitted to the search device, which may display the results on a user interface, or perform one or more functional tasks using the second results.

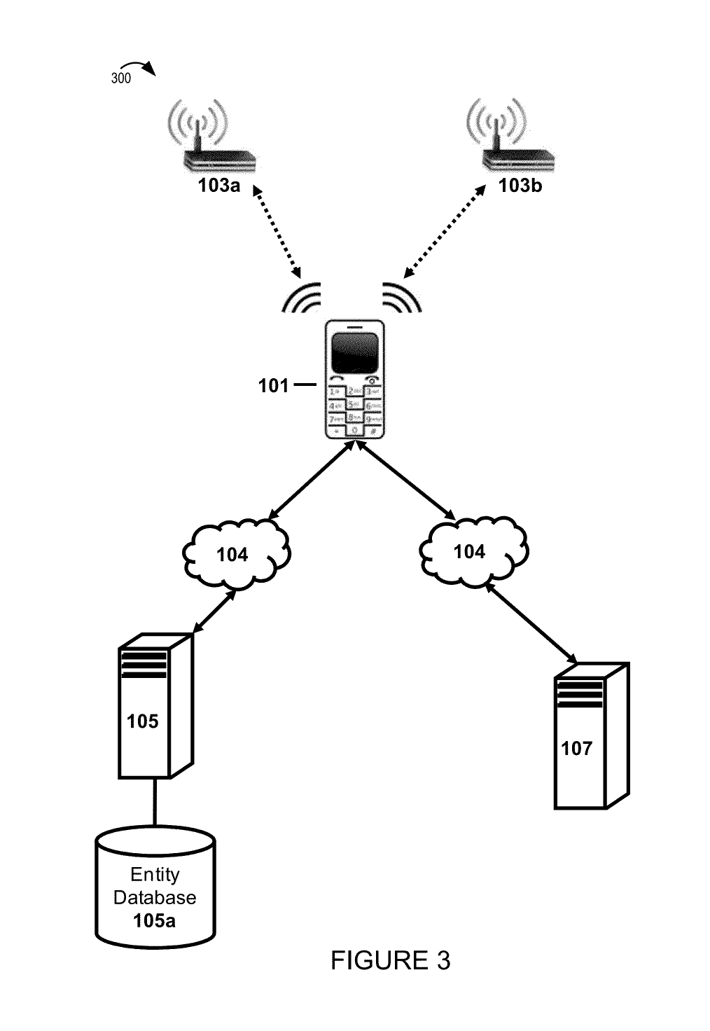

FIG. 3 shows components of a second exemplary system embodiment. The components of embodiments of this embodiment may be the same combination of components of embodiments described in FIG. 1.

However, in embodiments such as FIG. 3, the search device 101 of may transmit a search query to a first datastore 105, and then receive a first result back from the first datastore 105. The search device 101 may then generate a second query, based on the information strings received from wireless devices 103a and the data of the first result. The search device 101 may then transmit the second query to the second datastore 107, which may execute the second query. The second result may be transmitted directly back to the search device 101, by the second datastore 107.

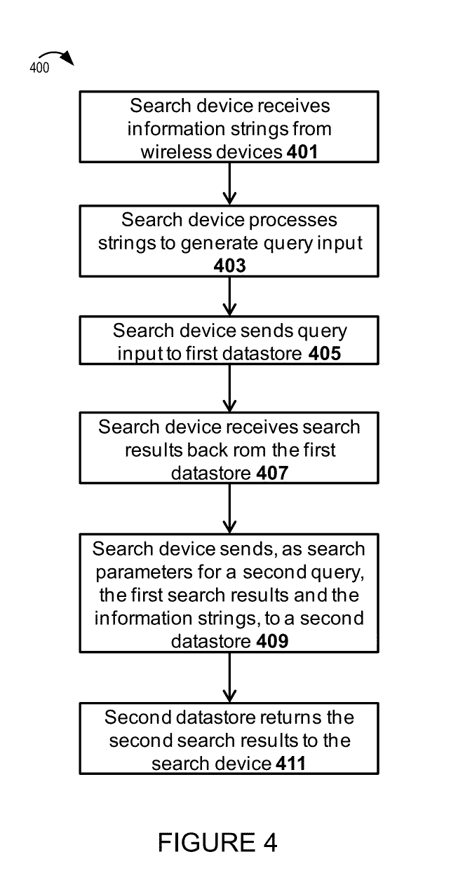

FIG. 4 shows steps performed by processors and software modules, according to an exemplary embodiment. In this and similar embodiments, a proximally-based database search may be initiated by a database when a search device sends proximity information (information strings geolocation information) to a first datastore, which may derive search information from the proximity information received from the search device, and then initiates a query of a second datastore (e.g. Google®) with that information. The second datastore returns search results to the search device. In some embodiments, the second datastore may return results to the first datastore, which may then processes the results and then returns the processed results to the search device.

In a first step 401, a search device may receive information strings from wireless devices. The search device may be receive any number of wireless signals, from any number of sources. The search device may select a subset of wireless signals from which the search device will extract an information string.

In a next step 403, the search device processes the information strings in order to generate a query. The search device may concatenate multiple information strings, or parts of information strings. The search device may parse data of the information strings to be more suitable for executing the search. The search device may also parse data of the information strings to generate a customized search query based on one or more factors.

In a next step 405, the search device may transmit the generated query to a first datastore. The generated query may use the data of the information string as the search parameters issued to the first datastore. The search device may also send, along with the information strings, data associated with the information strings.

In a next step 407, the first datastore may perform the first search query and return the first set of search results to the search device. After the search device receives the first search results back from the first datastore, the search device may prepare a second search query using parameters based on the first search results and the information strings.

In a next step 409, the search device may send the second query to the second datastore. The parameters of the second query prepared by the search device, may include the first search results and the information strings. The second datastore may then execute the second query based on this revised set of parameters.

In a next step 411, the second datastore may return a second set of results back to the search device, based on the second query.

The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, those skilled in the art will appreciate that one or more acts described herein may be performed by hardware, software, or a combination thereof, as may be embodied in one or more computing systems.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “tracking” or “associating” or “displaying” or “interacting” or “operating” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

Various embodiments are directed to a method of providing information to a device. The method may operate automatically in response to the device receiving signals, e.g., one or a set of signals satisfying one or more predetermined criteria that maybe and sometimes are set by a user of the communications device. The method in some embodiments includes receiving at a first data store, a query generated by the communications device from information strings communicated by wireless signals received by said communications device. The query maybe and sometimes is sent automatically when a set of signals communicating information strings is received and the signals and/or strings satisfy the predetermined criteria set by the user. The predetermined criteria maybe and sometimes do relate to a minimum received signal strength, type of information communicated by the received signal, source of the signal, etc. In response to receiving the query via an interface of the first data store, a processor in the first data store retrieve data associated in said first database with one or more information strings included in said first query. The retrieval process may and sometimes does involve searching memory in the first data store for content or information associated with one or more strings included in the first query. The information, e.g., data, returned as a result of the first query is sometimes used in generating a second query. Thus, in at least some embodiments the first data store generates a second query from the retrieved data obtained by implementing the first query at the first data stored. The second query maybe and sometimes does depend on and/or include one or more strings from the first query. Thus, the second query can and sometimes does include the information strings included in the first query plus at least some data retrieved from the first database in response to the first query. The strings and/or data included in the second query are communicated to a second data store and used as search parameters at the second data store as part of a query of the second data store. Thus in some embodiments the first data store generates and sends the second query to the second data store.

In response to the second query, the second data store conducts a search using the information strings and data as search parameters. The results of the search, e.g., data obtained form the second data store determined to match one or more of the information strings and/or data used as parameters in the second query, are returned by the second data store to the first data store as results of the second query. The first data store receives data retrieved from the second data store as a response to the second query. The first data store then returns to the first communications device, as a response to the first query, information included in or derived from the received results of the second query and/or results retrieved from the first data store in response to the first query. In some embodiment the first query includes a concatenation of multiple information strings received by said communications device in different wireless signals received by said communications device. In some embodiments the second query includes as search parameters one or more information strings obtained from the first query and data corresponding to the one or more information strings obtained form the first data store. In some embodiments the first data store updates one or more records included in the first data store based on the results of the second query received from the second data store. The updating may, and in some embodiments does include, adding to a record being updated data obtained from the second data store to thereby include, in addition to existing data in the record, data retrieved from the second data store. In some embodiments the at least one of the or more records which are updated include an information record corresponding to an information string included in the first query with the updating including adding to the record information obtained from the second data store information corresponding to the information string.

In some embodiments the method further comprises operating the communications device to display the information included in or derived from the received results of the second query, returned to said communications device, as a response to the first query, to a user of the communications device. In some embodiments the first query is initiated automatically by the communications device in response to receiving a set of signals satisfying a predetermined criteria, e.g., without receiving user input during or following receipt of said set of signals satisfying the predetermined criteria. The method sometimes also includes operating the communications device to automatically display the information returned to said communications device without requiring user input after receipt of the information to trigger said display. In this manner, a user may be provided with information relating to a set of received signals which triggered one or more data base lookups automatically providing the user with real time locally relevant information obtained from multiple data stores without the need or requirement for user input from the point where the signals are received to the point in time where the database results are automatically displayed to the user.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

Servers, databases, communications devices and other devices in the exemplary system in some embodiments each include a processor, memory and interface with such components in a device being are coupled together, e.g., by a bus and with the interface of the device coupling the device to other devices allowing the device to receive and send signals and/or information. The processor controls the device in which it is included to operate in accordance with the invention, e.g., in the manner described herein.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that numerous alternative components and embodiments that may be substituted for the particular examples described herein and still fall within the scope of the invention.

What is claimed is:

1. A method of providing information to a device, the method comprising:
receiving at a first data store, a query generated by a communications device from information strings communicated by wireless signals received by said communications device;
operating the first data store to retrieve data associated in said first database with one or more information strings included in said first query;
operating the first data store to generate a second query from the retrieved data and said first query;
operating the first data store to send the second query to a second data store;
receiving, at the first data store, results of the second query implemented by the second data stored; and
returning to said communications device, as a response to the first query, information included in or derived from the received results of the second query.

2. The method of claim 1, wherein the first query includes a concatenation of multiple information strings received by said communications device in different wireless signals received by said communications device.

3. The method of claim 2, wherein the second query includes as search parameters one or more information strings obtained from the first query and data corresponding to the one or more information strings obtained form the first data store.

4. The method of claim 3, further comprising:
operating the first data store to update one or more records based on the results of the second query received from the second data store.

5. The method of claim 4, wherein at least one of the or more records which are updated is a record corresponding to an information string included in the first query.

6. The method of claim 5, further comprising:
operating the communications device to display the information included in or derived from the received results of the second query, returned to said communications device, as a response to the first query, to a user of the communications device.

7. The method of claim 6,
wherein said first query is initiated automatically by the communications device in response to receiving a set of signals satisfying a predetermined criteria; and
wherein said communications device automatically displays the information returned to said communications device without requiring user input after receipt of the information to trigger said display.
